(19) United States
(12) Patent Application Publication
(10) Pub. No.: US 2025/0292435 A1
(43) Pub. Date: Sep. 18, 2025

(54) DEVICE, OPTICAL IMAGING SYSTEM, METHOD AND COMPUTER PROGRAM

(71) Applicant: Leica Microsystems CMS GmbH, Wetzlar (DE)

(72) Inventors: Holger BIRK, Wetzlar (DE); Frank HECHT, Wetzlar (DE); Manuel KREMER, Wetzlar (DE); Rene POEGE, Wetzlar (DE)

(21) Appl. No.: 19/079,502

(22) Filed: Mar. 14, 2025

(30) Foreign Application Priority Data
Mar. 18, 2024 (DE) 10 2024 107 560

(51) Int. Cl. G06T 7/73; G02B 21/00; H04N 17/00; H04N 23/60; H04N 23/74

(52) U.S. Cl. CPC G06T 7/74; G02B 21/008; H04N 17/002; H04N 23/64; H04N 23/74; G06T 2207/10056

(57) ABSTRACT

A device for an optical imaging system includes a data processing circuit and a memory. The data processing circuit is configured to receive sensor data indicative of a reference image, receive trigger data indicative of a trigger event for determining a drift of the optical imaging system, control recording a drift image triggered by the trigger event, receive further sensor data indicative of the drift image, determine a pixel offset between the reference image and the drift image, determine correction data for correcting the pixel offset based on the pixel offset and send the correction data to correct the pixel offset.

### CROSS REFERENCE TO RELATED APPLICATIONS

This application claims benefit to German Patent Application No. DE 10 2024 107 560.0, filed on Mar. 18, 2024, which is hereby incorporated by reference herein.

### FIELD

Embodiments of the present invention relate to a device for an optical imaging system, an optical imaging system, a method, and a computer program.

### BACKGROUND

For long-term measurements with an optical imaging system in the range of several minutes to several hours, several imaging sequences can be recorded with different excitation light and different spectral or temporal detection properties. This allows detailed information about a specimen, such as the color of a specimen, to be captured. For example, to record the specimen, a stack of images can be recorded at different axial (z) positions and a series of lateral (x/y) stage positions.

Due to instabilities, such as fluctuations in room temperature, drift cannot be completely avoided in the event of long-term measurements. The drift can lead to a shift in the recorded images during long-term measurement. The shift of the images can lead to incorrect information when imaging the specimen. There is thus a need to improve the imaging of a specimen through long-term measurement.

### SUMMARY

Embodiments of the present invention provide a device for an optical imaging system. The device includes a data processing circuit and a memory. The data processing circuit is configured to receive sensor data indicative of a reference image, receive trigger data indicative of a trigger event for determining a drift of the optical imaging system, control recording a drift image triggered by the trigger event, receive further sensor data indicative of the drift image, determine a pixel offset between the reference image and the drift image, determine correction data for correcting the pixel offset based on the pixel offset and send the correction data to correct the pixel offset.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a and 1b are schematic representations of a device for an optical imaging system and a corresponding optical imaging system according to some embodiments;

FIG. 2 is a flowchart of a method for compensating for drift according to some embodiments;

FIG. 3 is a flowchart of a method for compensating a drift according to some embodiments;

FIG. 4 shows an exemplary setting of a measurement region for recording a reference image according to some embodiments;

FIG. 5 shows a block diagram of a method according to some embodiments; and

FIG. 6 shows a schematic representation of a system comprising a microscope and a computer system according to some embodiments.

### DETAILED DESCRIPTION

Embodiments of the present invention are based on the finding that an imaging of a specimen obtained by a long-term measurement can be improved by correcting a pixel offset during the long-term measurement. Pixel offset can be corrected based on correction data. The correction data can be determined during the long-term measurement so that recorded images of the specimen can be corrected during the long-term measurement. That is to say, a device can perform a correction for an image of the specimen based on a pixel offset between a reference image and a drift image. Accordingly, drift compensation can be carried out by a device during long-term measurement.

Exemplary embodiments provide a device for an optical imaging system. The device comprises a data processing circuit and a memory. The device is designed to receive sensor data and trigger data. The sensor data is indicative of a reference image. The trigger data is indicative of a trigger event for determining a drift of the optical imaging system. Furthermore, the device is designed to control the recording of a drift image and to receive further sensor data triggered by the trigger event. The other sensor data is indicative of the drift image. Furthermore, the device is designed to determine a pixel offset between the reference image and the drift image. The device is further configured to determine correction data for correcting the pixel offset based on the pixel offset and to send the correction data for correcting the pixel offset. The trigger event and the resultant triggered recording of the drift image can be used to correct a drift in the optical imaging system. This correction can be based on a specific pixel offset between a reference image and a drift image. This means that the trigger event can be used to determine a pixel offset during a measurement by means of the optical imaging system. The determined pixel offset can be used to determine correction data, such as control commands for the optical imaging system. The correction data can therefore allow for compensation of drift during use of the optical imaging system. This allows a correction of a pixel offset during a long-term measurement to be carried out directly during the long-term measurement.

In one exemplary embodiment, determining the pixel offset may be determining an axial pixel offset and/or determining a lateral pixel offset. Accordingly, the correction data may be for correcting the axial pixel offset and/or the lateral pixel offset. This means that both an axial pixel offset and a lateral pixel offset can be compensated during use of the optical imaging system. For example, axial drift can be compensated in a confocal measurement.

In one exemplary embodiment, the correction data may be indicative of a setting of a field-of-view scanner or a setting of a specimen stage of the optical imaging system. This means that the device can determine correction data that can be used to align or adjust the optical imaging system. Accordingly, a setting of the optical imaging system can be changed based on the correction data. For example, to compensate for drift, a position of the specimen stage can be adjusted during use of the optical imaging system.

In one exemplary embodiment, the reference image may comprise a first focus map and the drift image may comprise a second focus map. The device may further be configured to determine a pixel offset by determining an offset of a position of a characteristic structure in the first focus map relative to a position of the characteristic structure in the second focus map. By using a focus map, axial drift in particular can be compensated better. For example, a reflection of a cover layer, which can lead to a characteristic peak in the focus map, can be used to determine an axial drift. By using the characteristic structure, for example a characteristic peak caused by a cover layer, the determination of the axial pixel offset can be improved.

In one exemplary embodiment, the trigger event may be indicative of exceeding a predefined measurement time, a predefined number of measurement sequences and/or a predefined temperature change. Accordingly, a drift check can be carried out continuously during use of the optical imaging system. This can prevent drift from remaining undetected during the measurement and leading to incorrect imaging of a specimen.

In one exemplary embodiment, controlling the recording of the drift image may comprise controlling a transmitted light detector of the optical imaging system. The additional sensor data can then be indicative of a drift image of the transmitted light detector. The use of a transmitted light detector can simplify and/or improve imaging of the specimen.

In one exemplary embodiment, the reference image or the drift image may be from a first channel of the optical imaging system and the correction data for correcting the pixel offset for recording a useful image may be from a second channel. A useful image can be an image of the specimen that is generated for display to a user. In contrast, the reference image and the drift image can only be used to compensate for drift. This means that the useful image can, for example, be part of a three-dimensional image of the specimen, which is recorded, for example, for display to a user. The first channel can be different from the second channel. This means that the correction data can be used to correct a useful image of a different channel than the channel of the reference image or drift image. For example, the reference image can be recorded for a first frequency and the useful image can be recorded for a second frequency different from the first frequency.

In one exemplary embodiment, the useful image may be a confocal image of a specimen. That is to say, the device can be used to compensate for drift during a confocal measurement of a specimen by means of the optical imaging system.

In one exemplary embodiment, determining the pixel offset may comprise determining by means of phase cross correlation. Using phase cross correlation, a pixel offset can be determined in a simplified manner.

In one exemplary embodiment, the device may be configured to receive wavelength data. The wavelength data is indicative of a change in the wavelength used for a measurement. Furthermore, the device can be designed to control a recording of the reference image triggered by the change in the wavelength. Accordingly, a measurement of a reference image can be triggered for the use of a wavelength. This allows a reference image to be recorded specifically for a single wavelength. This can improve the determination of the pixel offset by means of the drift image for a specific wavelength.

In one exemplary embodiment, the device may further be configured to receive position data. The position data is indicative of a change in the position of a specimen stage of the optical imaging system. Furthermore, the device can be designed to control a recording of the reference image triggered by the change in the position of the specimen stage. By recording the reference image triggered by the change in the position of the specimen stage, a reference image can be recorded for a lateral position at the beginning of a measurement. This can improve the determination of a pixel offset by means of the drift image for a specific lateral position.

In one exemplary embodiment, the device can be designed to determine a reliability of the determined correction data and to control the recording of the drift image based on the determined reliability. For example, the drift image can be recorded at shorter intervals if the reliability of the correction data falls below a limit value. This allows the determination of correction data to be adjusted to a current situation. For example, a strong drift in temperature can lead to a strong drift in the optical imaging system. Accordingly, the reliability of the correction data determined based on performed measurement sequences may be reduced. Due to the reduced reliability, the drift pattern could be determined, for example, after half of the measurement sequences, which could increase the reliability of the correction data.

In one exemplary embodiment, controlling the drift image may comprise adjusting a size of a measurement region. For greater reliability, a smaller measurement region can be set. This can reduce the time required to record the drift image. Accordingly, a measurement time of the specimen can be reduced by means of the optical imaging system.

In one exemplary embodiment, the region for recording the drift image can be adjusted in a lateral direction and/or an axial direction. Accordingly, time can be saved by reducing the region for recording the drift image for both a lateral direction and an axial direction.

In one exemplary embodiment, the device may be further configured to determine a reliability of the determined correction data and, based on the determined reliability, to determine the correction data for correcting the pixel offset. For example, if the reliability of the correction data falls below a limit value, no correction or a minor correction of a useful image can be made. This means that if the reliability of the correction data is low, the correction data can be adjusted so that the correction of the useful image can be reduced. For example, if the reliability of the correction data is low, a change in the lateral position of the specimen stage can be reduced. For example, the correction data can only be sent to provide sufficient reliability for correcting pixel offset.

In one exemplary embodiment, the device may further be configured to control a light source of the optical imaging system in a pulsed mode. Furthermore, the device can be designed to determine a characteristic structure in the reference image and in the drift image for determining an axial pixel offset, triggered by the pulsed mode of the light source. By controlling a pulsed mode of the light source, measurement signals that are unnecessary for determining the characteristic structure can be suppressed. For example, a fluorescence signal from the specimen can be suppressed by using a pulsed mode of the light source for the determination of the characteristic structure by evaluating only signals within a certain time window relative to the excitation pulse.

In one exemplary embodiment, the device may be configured to determine alignment data for recording an alignment image, send the alignment data for recording the alignment image, and receive alignment sensor data. The alignment sensor data is indicative of the alignment image. Furthermore, the device can be designed to determine a parameter of the optical imaging system for a correction of a lateral pixel offset or an axial pixel offset based on the alignment sensor data and the sensor data and to determine the correction data based on the determined parameter. The alignment image can therefore be used to determine the alignment or setting of the optical imaging system to achieve a pixel offset. For example, the device may send a control command to change an alignment of a field-of-view scanner. Based on the change of the field-of-view scanner, an alignment image can be received. By comparing the alignment image with an image recorded before the field-of-view scanner change, a pixel offset caused by the field-of-view scanner change can be determined. Accordingly, a pixel offset can be assigned to the change in the field-of-view scanner. This makes it possible to advantageously determine, in the case of a certain pixel offset caused by a drift, a necessary change in the alignment or setting of the optical imaging system.

In one exemplary embodiment, determining the alignment data may comprise determining a setting of a field-of-view scanner of the optical imaging system. The determined parameter is indicative of a correlation between the lateral pixel offset or axial pixel offset and the setting of the field-of-view scanner. This allows a certain pixel offset caused by drift during use of the optical imaging system to be advantageously compensated by adjusting the setting of the field-of-view scanner.

Exemplary embodiments provide an optical imaging system comprising a device as described above.

Exemplary embodiments provide a method. The method comprises receiving sensor data indicative of a reference image and receiving trigger data indicative of a trigger event for determining a drift of the optical imaging system. The method further comprises controlling a recording of a drift image triggered by the trigger event and receiving further sensor data indicative of the drift image. The method further comprises determining a pixel offset between the reference image and the drift image. The method further comprises determining, based on the pixel offset, correction data for correcting the pixel offset and sending the correction data for correcting the pixel offset.

Various examples of the present disclosure relate to a corresponding computer program having a program code for carrying out the above method when the computer program is executed on a processor.

Various examples will now be described in greater detail with reference to the accompanying drawings in which some examples are shown. In the figures, the thicknesses of lines, layers and/or regions may be exaggerated for clarity.

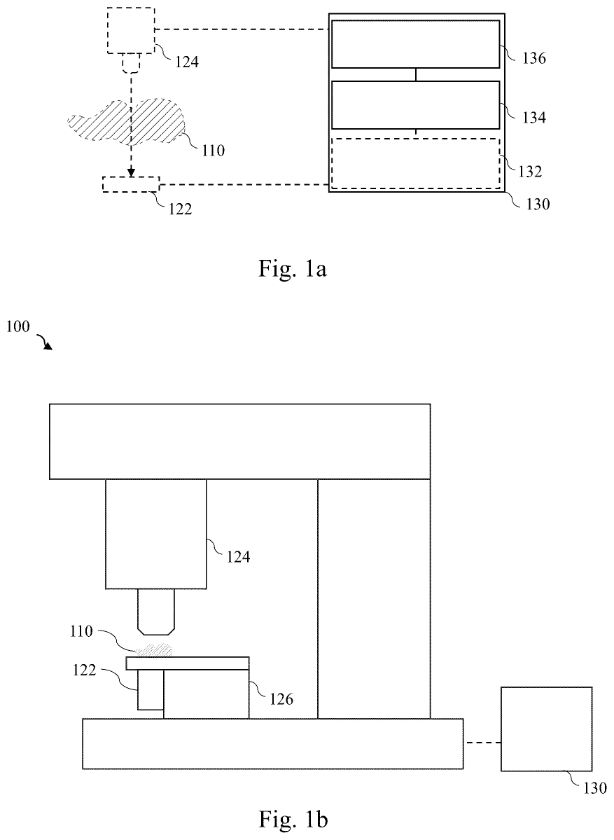

FIG. 1a and 1b are schematic representations of an example of a device 130 for an optical imaging system 100 and a corresponding optical imaging system 100 comprising the device 130. The device 130 may control various aspects of a microscope of the optical imaging system 100, which may be an optical imaging system, and the entire optical imaging system 100 and/or process various types of sensor data of the optical imaging system 100. Consequently, the device 130 may be implemented as a computer system that interfaces with the various components of the optical imaging system 100, e.g., the field-of-view scanner 124. The device 130 may be part of the optical imaging system 100. Alternatively, the apparatus 130 may be communicatively coupled to the optical imaging system 100. For example, the device 130 may be a ready-to-use module that can be connected to the optical imaging system 100.

The device 130 comprises, as shown in FIG. 1a, a data processing circuit 134 and a memory 136. Optionally, the device 130 also comprises one or more interfaces 132. The data processing circuit 134 is connected to the memory 136 and to the optional one or more interfaces 132. In general, the functionality of the device 130 may be provided by the data processing circuit 134 (e.g., for determining the correction data), in conjunction with the one or more interfaces 132 (for exchanging information, e.g., for sending the correction data), and/or with the memory 136 (for storing and/or retrieving information).

The device 130 is configured to receive sensor data. The sensor data is indicative of a reference image. The reference image can, for example, be recorded at the beginning of a measurement or a measurement sequence. The reference image can serve as a reference for a state of the optical imaging system 100 at a specific point in time, for example a start of a measurement or a measurement sequence. This means that the reference image can be used as a reference to determine drift. Accordingly, the device 130 may use the reference image to determine drift. The sensor data can be received, for example, from an image sensor, for example the transmitted light detector 122, of the optical imaging system 100. Alternatively, as described below, the sensor data can be read from a memory, for example the memory 136.

Drift can be caused by various factors, such as temperature change, vibration, mechanical stability, or electrical disturbance. Accordingly, the device 130 is further configured to receive trigger data. The trigger data is indicative of a trigger event for determining a drift of the optical imaging system 100. For example, a trigger event can be an exceeded temperature difference during the measurement or a vibration of the optical imaging system 100. For example, the device 130 can receive information about a temperature of the optical imaging system 100 or an environment of the optical imaging system 100 from a temperature sensor. Based on the information about the temperature, the device 130 can determine a temperature difference since the reference image was recorded. Accordingly, the device 130 can determine the trigger event itself. Optionally or alternatively, the device 130 can receive information about a vibration of the optical imaging system 100 from a motion sensor. In this case, the received information about the vibration of the optical imaging system 100 may be the trigger event. That is to say, the device 130 may receive the trigger event.

Furthermore, the device 130 is designed to control the recording of a drift image triggered by the trigger event. That is to say, the device 130 can control the recording of a drift image triggered by the trigger event so that a drift image can be recorded for comparison with the reference image. Accordingly, the trigger event can trigger a check of a drift of the optical imaging system 100.

Accordingly, the device 130 is configured to receive further sensor data. The other sensor data is indicative of the drift image. That is to say, the device 130 can receive the drift image of which the recording was controlled by the device 130.

In general, the drift image may be an image of the specimen 110 that, under ideal conditions, is comparable to an image of the specimen 110 of the reference image. For example, the drift image may be an image of a specimen 110 with the same setting of the optical imaging system 100 that was used to record the reference image. This means that the drift image and the reference image can be identical as long as no drift occurred between the recording of the reference image and the recording of the drift image. Accordingly, based on the reference image and the drift image, a change in an image due to a drift can be determined. Since the determination of the lateral offset of two images, i.e., the reference image and the drift image, requires a minimum of crosstalk or mutual information, lateral drift detection can be improved by using images with identical settings of the optical imaging system 100. Alternatively, the drift image can be recorded with a setting of the optical imaging system different from a setting used to record the reference image. For example, a characteristic structure can be determined in a focus map for different wavelengths. This means that the reference image and the drift image may have been recorded at different wavelengths. Alternatively or optionally, the reference image and the drift image may depict partially different regions of the specimen 110. As an alternative to lateral drift detection, a differential interference contrast can then be used as an alternative image contrast to determine the lateral offset. Differential interference contrast microscopy is a technique used for generating contrast in microscope images by utilizing the changes in the refraction of light at the edges and interfaces of specimen 110 structures. It can therefore be used to observe and measure lateral drift by detecting and analyzing changes in the contrast of structures in images.

The device 130 is designed to determine a pixel offset between the reference image and the drift image. By determining the pixel offset, an influence of a drift on the recording of an image of the specimen 110 can be determined. A pixel offset can be determined, for example, by comparing structures or image features in the reference image and the drift image. Optionally or alternatively, image registration techniques, such as phase cross correlation, may be used to determine a spatial shift of features or structures between the reference image and the drift image.

Furthermore, the device 130 is configured to determine correction data for correcting the pixel offset based on the pixel offset. The correction data can be, for example, control commands for the optical imaging system 100. For example, an alignment or setting of the optical imaging system 100 can be changed by the correction data. For example, the device 130 can control a change in a setting of the optical imaging system 100. As a result, a setting of the optical imaging system 100 can be changed so that compensation for the specific pixel offset can be achieved.

The device 130 is further configured to send the correction data for correcting the pixel offset. For example, the device 130 can send the correction data to an actuator of the optical imaging system 100. The actuator can be designed to change an alignment or adjustment of the optical imaging system 100. Alternatively, the device 130 can send correction data to a control unit of the optical imaging system 100. In this case, the device 130 can be an external component. That is to say, the device 130 can only be communicatively connected to the optical imaging system 100. Accordingly, the control unit of the optical imaging system 100 can change or control an alignment or adjustment of the optical imaging system 100 based on the correction data. By changing the alignment or setting of the optical imaging system 100, the pixel offset can be corrected. For example, a position of a specimen stage or an alignment of a field-of-view scanner 124 of the optical imaging system 100 can be adjusted.

By sending the correction data, a drift can be corrected during a measurement by means of the optical imaging system 100. That is to say, a drift of the optical imaging system 100 can be compensated during a recording of a specimen 110, for example a three-dimensional confocal recording of the specimen 110. It is a finding of the inventors that by compensating for drift during a measurement, an imaging of the specimen 110 can be improved. In particular, image post-processing after measurement can be eliminated or simplified. Image post-processing, i.e., moving images in a post-processing step, can cause various problems. For example, as a result of shifting in the opposite direction to the shift, data may be missing or the images may need to be cropped to a smaller format. For example, sub-pixel shifting may be required, which can introduce artifacts that can alter photon statistics. By using the device 130, post-processing can be avoided, which also allows the associated problems to be avoided.

Furthermore, a post-processing step can require a minimum amount of crosstalk between the images to be compared to determine a lateral shift. In multi-color experiments (e.g., fluorescence microscopy), however, the goal is to minimize crosstalk between images. Therefore, especially in multi-color experiments, a large number of recorded images may be unsuitable for detecting the lateral shift in a post-processing step. This means that the device 130 can offer a further advantage over a post-processing step, in particular in multi-color experiments.

The device 130 can therefore in particular control an axial correction and/or a lateral correction by changing an alignment or setting of the optical imaging system 100 before recording an image of the specimen 110. Accordingly, a post-processing step of a recorded image of the specimen 110 can be omitted.

The proposed concept may be built around two main components-the microscope, which comprises the optical components, e.g., the field-of-view scanner 124, used to view the specimen 110, and the device 130, which may be used to control the optical imaging system 100, to process sensor data from the microscope, e.g., the transmitted light detector 122, and/or to generate correction data.

In general, a microscope is an optical instrument suitable for examining objects that are too small to be examined with the human eye (alone). For example, a microscope can provide optical magnification of a specimen, such as specimen 110 shown in FIG. 1. In modern microscopes, optical magnification is often provided by a camera or image sensor. The microscope may further include one or more optical magnification components used to magnify a view of the specimen 110.

There are many different types of optical imaging systems. When the optical imaging system 100 is used in the medical or biological field, the specimen 110 may be a specimen of organic tissue, for example arranged in a Petri dish or located in a body part of a patient. For example, the optical imaging system 100 can be used for confocal microscopy. However, the proposed concept can also be applied to other types of microscopy, such as microscopy for the purpose of materials testing.

FIG. 1b shows a schematic representation of an example of an optical imaging system 100 comprising a microscope and the device 130. In general, an optical imaging system is a system that comprises a microscope and additional components that operate together with the microscope. In other words, an optical imaging system 100 is a system that comprises the microscope and one or more additional components, such as the device 130 (which may be a computer system configured to control the microscope and, for example, to generate the correction data), an illumination system (which is used to illuminate a specimen imaged by the microscope and can be controlled by the device 130), additional sensors, displays, etc. As can be seen in FIG. 1b, the optical imaging system 100 may comprise further components, for example a transmitted light detector 122, a field-of-view scanner 124 and/or a specimen stage 126.

In one exemplary embodiment, determining the pixel offset may be determining an axial pixel offset and/or determining a lateral pixel offset. In particular, an axial correction and/or a lateral correction can be performed. For example, an axial correction may be performed first since axial drift is usually a dominant drift effect. Accordingly, an axial correction can first be performed for the dominant drift effect. Axial drift can be determined, for example, by using a focus map. A lateral drift can be determined, for example, by phase cross correlation.

In one exemplary embodiment, the correction data may be indicative of a setting of a field-of-view scanner 124 and/or a setting of a specimen stage 126 of the optical imaging system. For example, the control data can be used to adjust a setting of a field-of-view scanner 124 and/or a specimen stage 126. In other words, the device 130 can control a change in the setting of the field-of-view scanner 124 and/or the specimen stage 126. This allows a pixel offset to be advantageously compensated during a measurement of the specimen. For example, an alignment of the field-of-view scanner can be changed such that the field-of-view is shifted opposite to the specific pixel offset by the same number of pixels as the pixel offset.

A field-of-view scanner is a device for precisely moving the field of view over a specimen. The field-of-view scanner can be designed either as a standalone unit or as an extension of the microscope. The field-of-view scanner allows for precise movements in the horizontal (x) and vertical (y) directions and/or axial (z) directions. This allows the field of view to be precisely aligned on a region of the specimen. Using a field-of-view scanner can provide high accuracy and repeatability in field-of-view positioning. In particular, the use of a field-of-view scanner can be advantageous when recording an alignment image.

In principle, a field-of-view scanner can be a device designed to adjust a field of view. For example, a field-of-view scanner may comprise galvanometric scanning mirrors, typically arranged in a system of at least two mirrors, to precisely move the field of view. The main focus can be on scanning a large image field with high homogeneity without compromising scanning speed. A field-of-view scanner comprising galvanometric scanning mirrors can allow for functions such as zoom and pan as well as adjustment of the scan frequency. Alternatively, the field-of-view scanner can be a resonant scanner. A resonant scanner may comprise a mirror that oscillates at a resonant frequency. This allows for fast and precise movement of the field of view, for example for an application that requires a high frame rate. The use of mirrors can in particular allow for movement of the field of view in a lateral direction (in the xy plane). To move the field of view in the axial direction, a piezoelectric device and/or a galvanometer can optionally be used. Optionally, a focus change can also be used by means of an adjustable lens to move the field of view in the axial direction. Optionally or as an alternative to the field-of-view scanner, a movement of the field-of-view in the axial direction can be allowed by a precision mechanism on the specimen stage.

In one exemplary embodiment, the reference image may comprise a first focus map and the drift image may comprise a second focus map. The device 130 may further be configured to determine a pixel offset by determining an offset of a position of a characteristic structure in the first focus map relative to a position of the characteristic structure in the second focus map. A focus map is a representation of the focal plane or the focal distribution of an object, for example of the specimen 110, depending on depth or axial position. By scanning an object at different depths or focal planes, a focus map can be created. A focus map can indicate an intensity of reflected or emitted light depending on the position of the focal plane. A focus map can be used, for example, in light microscopy or confocal microscopy.

A focus map can be used to reconstruct a three-dimensional structure of an object or to determine which regions of the object are in focus or out of focus at different depths. This can be advantageous in particular for detailed examinations of the structure of cells, tissues or materials.

For example, the focus map can be used to determine a characteristic structure of the specimen 110 or a measurement setup. For example, a cover layer can be used to fix the specimen 110. The cover layer influences the refraction of light and thus the focal plane. Accordingly, a reflection of the cover layer can be determined in the focus map. In particular with high-resolution microscopic techniques such as confocal microscopy, a determination of a reflection caused by a covering layer in a focus map can be advantageous. That is to say, the characteristic structure for determining the offset of the position of the characteristic structure may comprise or be determining an offset of a reflection associated with a cover layer in the first focus map to the second focus map. For example, to measure the axial position, a peak in the reflection signal of the transition between the specimen 110 and the cover layer can be determined. This peak in the reflection signal can serve as a reference for axial positioning. That is to say, an offset of this peak in the reflection signal can be used to determine a pixel offset. The peak in the reflection signal can be caused by a change in the refractive index at the transition to the cover layer.

For example, the focus map may comprise a plurality of images of the specimen 110 recorded for a plurality of different positions of the specimen stage 126. This means that the reference image can comprise a plurality of recorded images. For example, the focus map may comprise images from three different positions of the specimen stage 126. Based on the three images for the three different positions of the specimen stage 126, it can be determined in which plane the specimen 110 lies. This allows a search range and/or starting value for the determination of the peak in the axial direction to be optimized.

Furthermore, by scanning the specimen 110 at different depths or focal planes, the focus map can show how the refraction of light through the cover layer affects the image of the specimen 110. This can be important to ensure that the recorded images can be correctly interpreted and to avoid artifacts that may be caused by the presence of the cover layer. In addition, the focus map may also comprise other characteristic structures of the specimen 110. These can be, for example, cell structures, tissue structures, microbial structures. This means that, as an alternative to a peak in the reflection signal triggered by the cover layer, structures of the specimen 110 can also be used for axial positioning.

In one exemplary embodiment, the trigger event may be indicative of exceeding a predefined measurement time, a predefined number of measurement sequences and/or a predefined temperature change. In particular, the trigger event can be selected in such a way that a control of a recording of a drift image is triggered at predefined intervals. For example, a drift image can be recorded at regular or irregular intervals. In particular, a predefined measurement time or a predefined number of measurement sequences can be used for a regular check of drift. This can ensure that a drift of the optical imaging system 100 is detected. Optionally or alternatively, the trigger event may also be related to changes in the environment and/or events at the optical imaging system 100. For example, a temperature change within a certain time period can be a trigger event. The temperature change can be determined by means of a temperature sensor, as described above. For example, a vibration of the optical imaging system 100 can be a trigger event. Accordingly, a drift image recording can be controlled based on an external influencing factor. This can improve monitoring for drift.

Optionally, after recording a drift image and determining the pixel offset, the drift image can be stored as a new reference image. For example, during a measurement at one position, it may be necessary to measure a large number of reference images and drift images. In this case, a drift image can be stored, for example, in the memory 136 and loaded as a reference image for later determination of a pixel offset. That is to say, the reference image can be obtained by reading from a memory.

In one exemplary embodiment, controlling the recording of the drift image may comprise controlling a transmitted light detector 122 of the optical imaging system 100. The further sensor data can then be indicative of a drift image of the transmitted light detector 122. Images recorded with a transmitted light detector 122 are typically bright and produce significant contrast, independently of specific colorations. This can improve the determination of lateral offset.

In one exemplary embodiment, the reference image or the drift image may be from a first channel of the optical imaging system 100 and the correction data for correcting the pixel offset for recording a useful image may be from a second channel. The first channel can be different from the second channel. A channel of an optical imaging system 100 may comprise information from a specific wavelength range, for example a wavelength range of a fluorescent dye or marker or a frequency spectrum of a fluorescent dye or marker. This means that a channel can be specifically designed to detect a signal of a particular wavelength or spectral range. Accordingly, the reference image and/or the drift image can be from a first channel and the useful image from a second channel. That is to say, the reference image and/or the drift image can be used to correct a drift for another channel for imaging the specimen 110.

In one exemplary embodiment, the useful image may be a confocal image of a specimen 110. That is to say, the device 130 can be used to compensate for drift during a confocal measurement of a specimen 110 by means of the optical imaging system 100. The confocal image can in particular comprise a plurality of useful images. The variety of useful images can be from different channels. For example, a drift determination can be made for one channel or a combination of two channels and used for at least one other channel.

In one exemplary embodiment, determining the pixel offset may comprise determining by means of phase cross correlation. Using phase cross correlation, a pixel offset can be determined in a simplified manner. In particular, phase cross correlation can be used to determine a lateral drift or a lateral offset. By using phase cross correlation, sub-pixel accuracy can in particular be achieved.

In one exemplary embodiment, the device 130 may be configured to receive wavelength data. The wavelength data is indicative of a change in the wavelength used for a measurement. Furthermore, the device 130 can be designed to control a recording of the reference image triggered by the change in the wavelength. Accordingly, if the measurement condition changes, a reference image can be recorded. This makes it possible, for example, to record a reference image for a channel before the measurement.

In one exemplary embodiment, the device 130 may further be configured to receive position data. The position data is indicative of a change in the position of a specimen stage 126 of the optical imaging system 100. The change in the position of the specimen stage 126 may involve a change in the position of the specimen 110 relative to the specimen stage 126. A change in the position of the specimen stage 126 relative to the specimen 110 can be caused by a drift of an objective, a drift of the objective stage 126 and/or an offset of the field-of-view scanner 124.

Furthermore, the device 130 can be designed to control a recording of the reference image triggered by the change in the position of the specimen stage 126. Accordingly, if the measurement condition changes, the reference image can be recorded. A change in the measurement condition can, for example, be a movement of the specimen stage 126.

In one exemplary embodiment, the device 130 can be designed to determine a reliability of the determined correction data and to control the recording of the drift image based on the determined reliability. Based on the reliability, a drift image recording can be adjusted. For example, if reliability is low, the rate at which the drift image is recorded can be increased. This means that with a low level of reliability, a drift image can be recorded at shorter intervals and/or after fewer measurement sequences than with a higher level of reliability. This can improve the reliability of drift determination.

In one exemplary embodiment, controlling the drift image may comprise adjusting a size of a measurement region. For greater reliability, a smaller measurement region for the drift image can be set. For example, a region of the field of view can be only partially measured. This means that instead of recording a drift image over the entire field of view, only a portion of the field of view can be recorded. Accordingly, the drift image can only comprise a part of the field of view, which can accelerate the recording of the drift image.

In one exemplary embodiment, the region for recording the drift image can be adjusted in a lateral direction and/or an axial direction. By adjusting the lens in a lateral direction, a recording can be limited to a part of the field of view. When adjusting in the axial direction, a scanned depth can be adjusted and/or a distance between individual depth scans. If a characteristic structure is used in a focus map to determine the axial offset, care must be taken to ensure that the characteristic structure is recorded in the axial direction despite the reduced image size.

In one exemplary embodiment, the device 130 may be further configured to determine a reliability of the determined correction data and, based on the determined reliability, to determine the correction data for correcting the pixel offset. For example, if the reliability of the correction data falls below a limit value, no correction or a minor correction of a useful image can be made. This means that, if the reliability of the correction data is low, the correction data can be adjusted so that the correction of the useful image can be reduced or excluded. For example, the correction data can only be sent to provide sufficient reliability for correcting pixel offset. That is to say, the device 130 can be designed to send the correction data only if there is sufficient reliability.

The reliability of the determination of the axial offset can be derived from the course of the reflection signal depending on the axial position. The reliability of the radial offset determination can be determined by motion analysis and object tracking.

In one exemplary embodiment, the device 130 may further be configured to control a light source of the optical imaging system in a pulsed mode. Furthermore, the device 130 can be designed to determine a characteristic structure in the reference image and in the drift image for determining an axial pixel offset, triggered by the pulsed mode of the light source. By controlling a light source in a pulsed mode, fluorescence signals from the specimen 110 can be suppressed. In particular, to determine a reflection of a covering layer, only one signal, i.e., photons, can be taken into account, which is detected in a small time window. That is to say, the pulsed mode of the light source can allow for a separation of a signal of the specimen 110 from a signal of another structure, e.g., a cover layer. For example, photons generated by fluorescence of the specimen 110 may arrive at an image sensor, e.g., the transmitted light detector 122, with a delay. This allows fluorescence signals from the specimen 110 to be separated from those of the cover layer. This can improve the determination of axial offset. Furthermore, the pulsed mode of the light source (and the short coherence length of pulsed light sources) can reduce or avoid interference effects at optical interfaces. This can improve the determination of axial offset and/or radial offset.

In one exemplary embodiment, the device 130 may be configured to determine alignment data for recording an alignment image, send the alignment data for recording the alignment image, and receive alignment sensor data. The alignment sensor data is indicative of the alignment image. Furthermore, the device 130 can be designed to determine a parameter of the optical imaging system 100 for a correction of a lateral pixel offset or an axial pixel offset based on the alignment sensor data and the sensor data and to determine the correction data based on the determined parameter. The alignment image can therefore be used to determine the alignment or setting of the optical imaging system 100 to achieve a pixel offset. For example, the device may send a control command to change an alignment of a field-of-view scanner 124.

The alignment image can be recorded after the reference image. In particular, the alignment image can be recorded immediately after the reference image. In this way, any change caused by drift between the recording of the reference image and the alignment image can be kept as low as possible or even eliminated. For example, the alignment image may be a second image of the specimen 110 for determining a lateral deflection due to a change in an alignment or setting of the optical imaging system 100. The alignment image can therefore have a defined offset, e.g., an offset of the field-of-view scanner 124. The defined offset of the alignment image in contrast to the drift image can be used to determine a correction parameter, i.e., a required alignment or setting of the optical imaging system 100, to compensate for a specific pixel offset. Based on the alignment image, it can be determined which change in the optical imaging system 100 causes which offset for correction. Furthermore, the alignment image can also be used to determine the reliability of the pixel offset determination.

In addition, the imaging image can be used to determine reliability. The reliability can be determined by recording two images of the specimen 110, the reference image and the alignment image, and by the known offset of the field-of-view scanner 124 for the alignment image. Comparing the calculated offset between the two images and the offset of the field-of-view scanner 124 can be used to verify the lateral displacement measurement and/or to determine reliability. For sufficient reliability, the measurement of the drift image and/or other reference images can be carried out on a smaller surface to save measurement time, see also FIG. 4.

In one exemplary embodiment, determining the alignment data may comprise determining a setting of a field-of-view scanner 124 of the optical imaging system 100. The determined parameter is indicative of a correlation between the lateral pixel offset and/or axial pixel offset and the setting of the field-of-view scanner 124. This allows a specific pixel offset caused by drift during use of the optical imaging system 100 to be advantageously compensated by adjusting the setting of the field-of-view scanner 124.

The device 100 can be used to perform lateral and/or axial drift correction for an optical imaging system 100. In particular, a transmitted light detector 122 can be used to record the reference image and the drift image. The transmitted light detector 122 can record a plurality of images of the specimen 110. The first image recorded of the specimen can be used as a reference image. The reference image can be compared with a later recorded image, the drift image, to determine a lateral and/or axial pixel offset.

Optionally, a second image, an alignment image, can be recorded after the reference image has been recorded, for example immediately afterwards. This means that the reference image and the alignment image can be two consecutive images. The alignment image can be recorded with a defined offset of the field-of-view scanner 124. For the alignment image, drift compared to the reference image can be negligible. The alignment image can be used to verify the reliability of the drift correction and/or to determine a required setting of the optical imaging system for drift correction.

A specific lateral and/or axial drift can then be corrected by correction data. For example, the correction data may be indicative of an adjustment of the position or an alignment of the field-of-view scanner 124. A drift check and optional drift correction can be performed for a variety of wavelengths during a measurement.

As shown in FIG. 1a, the interface 132 can be coupled to the relevant data processing circuit 134 of the device 130. In examples, the device 130 may be implemented by one or more processing units, one or more processing apparatuses, any means of processing such as a processor, a computer, or a programmable hardware component operable with appropriately adjusted software. Likewise, the described functions of the data processing circuit 134 can also be implemented in software, which is then executed on one or more programmable hardware components. Such hardware components can be a general-purpose processor, a digital signal processor (DSP), a microcontroller, etc. The data processing circuit 134 may be capable of controlling the interface 132 such that any data transfer that occurs over the interface 132 and/or any interaction that may involve the interface 132 may be controlled by the data processing circuit 134.

In one embodiment, the device 130 may comprise a memory and at least one data processing circuit 134 operably coupled to the memory and configured to perform the method described below.

In examples, interface 132 may correspond to any means for obtaining, receiving, transmitting, or providing analog or digital signals or information, e.g., any port, contact, pin, register, input port, output port, conductor, trace, etc. that allows the provision or receipt of a signal or information. The interface 132 may be wireless or wired and may be configured to communicate with other internal or external components, such as sending or receiving signals or information.

The device 130 may be a computer, a processor, a controller, a (field) programmable logic array ((F)PLA), a (field) programmable gate array ((F)PGA), a graphics processor unit (GPU), an application-specific integrated circuit (ASIC), an integrated circuit (IC), or a system-on-a-chip (SoC).

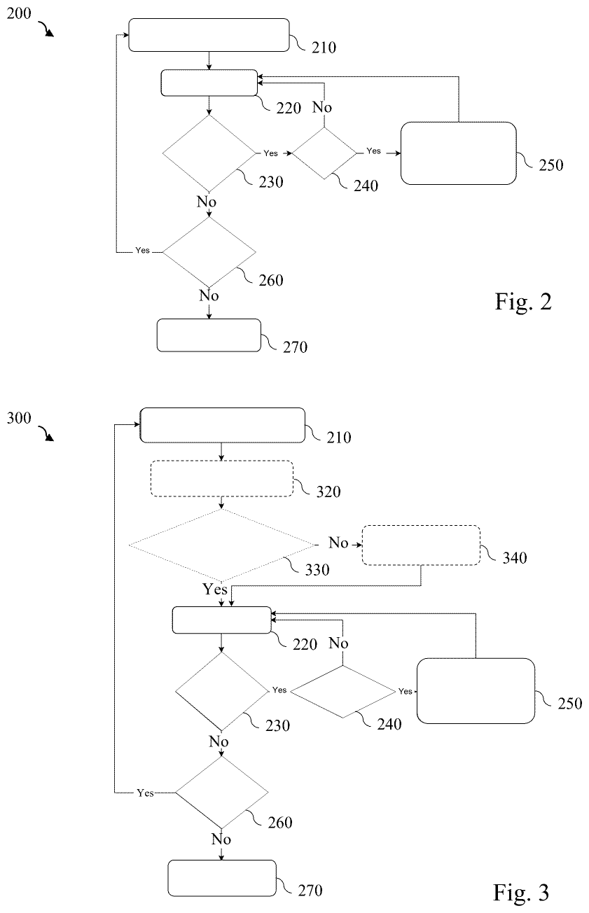

Further details and aspects are mentioned in connection with the exemplary embodiments described below. The exemplary embodiment shown in FIG. 1 may comprise one or more optional additional features corresponding to one or more aspects mentioned in connection with the proposed concept or one or more exemplary embodiments described below (e.g., FIG. 2-6).

FIG. 2 shows a flowchart of an example of a method 200 for compensating for drift. The method 200 can be carried out, for example, by a device as described with reference to FIG. 1.

The method 200 comprises receiving sensor data in 210. The sensor data is indicative of at least one reference image, for example an axial reference position and/or a lateral determination reference image. In particular, a reference image can be received for a plurality of positions of the specimen stage. This means that during a long-term measurement, sensor data can be received for a plurality of positions after setting a new position.

For example, the first measured image of a measurement sequence at a position on the specimen stage can serve as a reference image. Based on the reference image, a lateral pixel offset can be determined. In 220, additional useful images of the specimen can be recorded. In 230, a check can be carried out as to whether another measurement sequence should be carried out at the same position of the specimen stage or with the same settings of the optical imaging system.

If a further measurement sequence is to be carried out, a trigger event can be checked in 240. In other words, the device can receive trigger data that is indicative of a trigger event. For example, after a time t>t_{D} or after a predefined number of sequences S>S_{D}, a recording of a drift image can be controlled by the device. If no trigger event occurs, additional useful images can be recorded in 220. Alternatively, if a trigger event is present, the recording of a drift image can be controlled in 250. This means that a recording of at least one drift image can be controlled to determine an axial pixel offset and/or a lateral pixel offset. Based on the reference image and the drift image, correction data can be determined to adjust the alignment or adjustment of the optical imaging system. For example, the correction data can be used to adjust an alignment or position of the specimen stage (e.g., an axial position) and/or the field-of-view scanner (e.g., a lateral position). Accordingly, the device can trigger an adjustment of the optical imaging system, whereby a pixel offset can be corrected. After correcting the pixel offset, additional useful images can be recorded in 220.

If no further sequence is to be carried out at the same location, i.e., with the same setting of the optical imaging system, another position of the specimen stage can be set in 260. If another position of the specimen stage is set in 260, the method 200 can be continued with step 210. If no further position of the specimen stage is set in 260, the recording of the specimen can be completed or ended in 270. Optionally, in 270, a post-processing of an image of the specimen measured by the recording can be carried out. For example, unmixing of different channels can be performed.

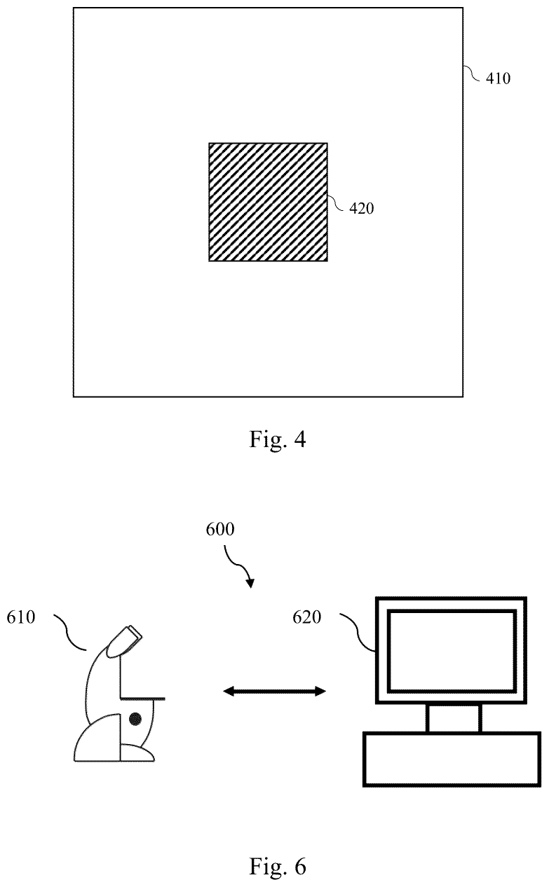

Further details and aspects are mentioned in connection with the exemplary embodiments described above and/or below. The exemplary embodiment shown in FIG. 2 may comprise one or more optional additional features corresponding to one or more aspects mentioned in connection with the proposed concept or one or more exemplary embodiments described above (e.g., FIG. 1) and/or exemplary embodiments described below (e.g., FIG. 3-6).

FIG. 3 shows a flowchart of another example of a method 300 for compensating for drift. The method 300 may, for example, be performed by a device as described with reference to FIG. 1.

In 210, the method 300 comprises receiving sensor data analogously to the method of FIG. 2. Likewise, the device in 220, 230, 240, 250, 260, 270 can perform analogous operations to the method of FIG. 2.

In principle, the method 300 differs from the method of FIG. 2 by the further optional operations in 320, 330, 340.

In 320, alignment data can be received. The alignment data is indicative of an alignment image. The alignment image may be a second lateral determination reference image. The alignment image can be recorded at a specific offset of a field-of-view scanner and/or a specimen stage. By determining the alignment image, a reliability or quality of the position determination can be determined in 330. For example, a measured lateral offset can be compared with an expected lateral offset by changing a setting of the field-of-view scanner. If the quality of the position determination is inadequate, a correction for the corresponding position of the specimen stage for the corresponding pixel offset, i.e., a lateral pixel offset and/or an axial pixel offset, can be deactivated in 340. For example, only a correction for a lateral pixel offset can be deactivated. This can ensure that the specific correction data is suitable for correcting the pixel offset.

Further details and aspects are mentioned in connection with the exemplary embodiments described above and/or below. The exemplary embodiment shown in FIG. 3 may comprise one or more optional additional features corresponding to one or more aspects mentioned in connection with the proposed concept or one or more exemplary embodiments described above (e.g., FIG. 1-2) and/or exemplary embodiments described below (e.g., FIG. 4-6).

FIG. 4 shows an example setting of a measurement region for recording a reference image. As described with reference to FIG. 1, a setting for recording a drift image can be varied based on reliability. In general, a reference image can also be recorded with a smaller measurement region than possible.

As can be seen in FIG. 4, the measurement region for the reference image 420 is smaller than the field of view 410. This can reduce the time required to record the reference image 420. The same applies to recording a drift image. Alternatively, the reference image 420 could also be a drift image.

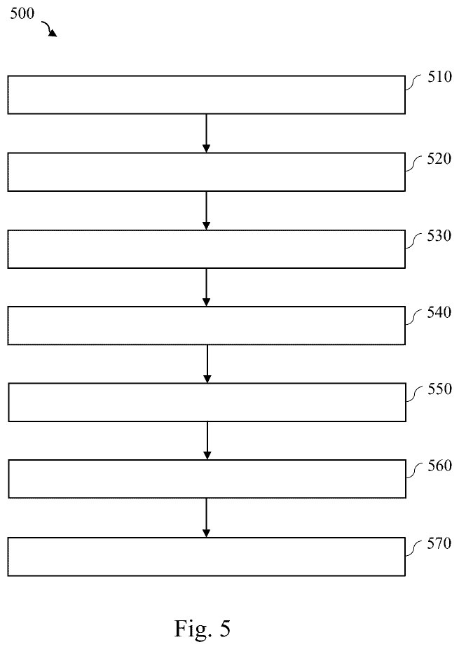

Further details and aspects are mentioned in connection with the exemplary embodiments described above and/or below. The exemplary embodiment shown in FIG. 4 may comprise one or more optional additional features corresponding to one or more aspects mentioned in connection with the proposed concept or one or more exemplary embodiments described above (e.g., FIG. 1-3) and/or exemplary embodiments described below (e.g., FIG. 5-6).

FIG. 5 shows a block diagram of another exemplary embodiment of the method 500. The method 500 comprises receiving 510 sensor data indicative of a reference image and receiving 520 trigger data indicative of a trigger event for determining a drift of the optical imaging system. The method 500 further comprises controlling 530 a recording of a drift image triggered by the trigger event and receiving 540 further sensor data indicative of the drift image. The method 500 further comprises determining 550 a pixel offset between the reference image and the drift image. The method 500 further comprises determining 560, based on the pixel offset, correction data for correcting the pixel offset and sending 570 the correction data for correcting the pixel offset. The method 500 can be carried out by a device as described above, for example with reference to FIG. 1.

Further details and aspects are mentioned in connection with the exemplary embodiments described above and/or below. The exemplary embodiment shown in FIG. 5 may comprise one or more optional additional features corresponding to one or more aspects mentioned in connection with the proposed concept or one or more exemplary embodiments described above (e.g., FIG. 1-4) and/or exemplary embodiments described below (e.g., FIG. 6).

Some embodiments relate to a microscope having a device as described in connection with FIG. 1. Alternatively, a microscope or optical imaging system may be communicatively coupled to a device as described in connection with FIG. 1. FIG. 6 shows a schematic representation of a system 600, e.g., an optical imaging system, configured to perform a method described herein, e.g., with reference to FIG. 2-5. The system 600 consists of a microscope 610 and a computer system 620. The microscope may comprise the device described above, e.g., the device described with reference to FIG. 1. The microscope 610 is configured to record images and is connected to the computer system 620. The computer system 620 is configured to carry out at least a part of a method described herein. The computer system 620 may be configured to execute a machine learning algorithm. The computer system 620 and the microscope 610 may be separate units, but may also be integrated in a common housing. The computer system 620 can be part of a central processing system of the microscope 610 and/or the computer system 620 can be part of a sub-component of the microscope 610, such as a sensor, an actuator, a camera or an illumination unit, etc. of the microscope 610.

The computer system 620 may be a local computer apparatus (e.g., personal computer, laptop, tablet computer, or mobile phone) having one or more processors and one or more storage apparatuses, or may be a distributed computer system (e.g., a cloud computer system having one or more processors and one or more storage apparatuses distributed at various locations, e.g., at a local client and/or one or more remote server farms and/or data centers). The computer system 620 can comprise any type of circuit or combination of circuits. In one embodiment, the computer system 620 may include one or more processors of any type. As used herein, the term “processor” may refer to any type of computing circuit, such as a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), a multi-core processor, a field programmable gate array (FPGA), e.g., of a microscope or microscope component (e.g., camera), or any other type of processor or processing circuit. Other types of circuits that may be contained in the computer system 620 may be a customer-specific circuit, an application-specific integrated circuit (ASIC) or the like, such as one or more circuits (e.g., a communication circuit) for use in wireless apparatuses, such as mobile phones, tablet computers, laptops, two-way radios and similar electronic systems. The computer system 620 may include one or more storage devices, which may comprise one or more storage elements appropriate for the particular application, such as a main memory in the form of a random access memory (RAM), one or more hard disks, and/or one or more drives that handle removable media such as compact discs (CDs), flash memory cards, digital video disks (DVDs), and the like. The computer system 620 can also contain a display apparatus, one or more speakers, and a keyboard and/or control apparatus, which can comprise a mouse, a trackball, a touchscreen, a voice recognition apparatus or any other apparatus that allows a system user to input information into and receive information from the computer system 620.

Further details and aspects are mentioned in connection with the above-described exemplary embodiments. The exemplary embodiment shown in FIG. 6 may comprise one or more optional additional features corresponding to one or more aspects mentioned in connection with the proposed concept or one or more above-described exemplary embodiments (e.g., FIG. 1-5).

Some or all of the method steps may be carried out by (or using) a hardware apparatus such as a processor, a microprocessor, a programmable computer, or an electronic circuit. In some embodiments, one or more of the most important method steps can be carried out by such an apparatus.

Depending on specific implementation requirements, embodiments of the invention may be implemented in hardware or software. The implementation may be carried out with use of a non-transitory storage medium such as a digital storage medium, for example a floppy disk, a DVD, a Blu-ray, a CD, a ROM, a PROM and EPROM, an EEPROM or a FLASH memory, on which electronically-readable control signals are stored that interact (or can interact) with a programmable computer system so that the particular method is carried out. The digital storage medium may therefore be computer-readable.

Some embodiments of the invention comprise a data carrier having electronically readable control signals that can cooperate with a programmable computer system so that one of the methods described herein is carried out.

In general, embodiments of the present invention can be implemented as a computer program product having a program code, wherein the program code is used for carrying out one of the methods when the computer program product is running on a computer. The program code can be stored on a machine-readable carrier, for example.

Further embodiments comprise the computer program for carrying out one of the methods described here, which computer program is stored on a machine-readable carrier.

In other words, an embodiment of the present invention is therefore a computer program having a program code for carrying out one of the methods described herein when the computer program is running on a computer.

Another embodiment of the present invention is therefore a storage medium (or a data carrier or a computer-readable medium) on which the computer program for carrying out one of the methods described herein when executed by a processor is stored. The data carrier, the digital storage medium or the recorded medium are typically tangible and/or not transferable. Another embodiment of the present invention is an apparatus as described herein, which comprises a processor and the storage medium.

Another embodiment of the invention is therefore a data stream or a signal sequence which represents the computer program for carrying out one of the methods described herein. The data stream or the signal sequence can be configured, for example, in such a manner that it is transmitted via a data communication connection, e.g., via the Internet.

Another embodiment comprises a processing means, e.g., a computer or programmable logic device, configured or adjusted to carry out one of the methods described herein.

Another embodiment comprises a computer on which the computer program for carrying out one of the methods described herein is installed.

A further embodiment of the invention comprises a device or a system configured to transmit a computer program for carrying out one of the methods described herein to a receiver (e.g., electronically or optically). The receiver can be, for example, a computer, a mobile apparatus, a storage apparatus or similar. The device or system can, for example, comprise a file server for transmitting the computer program to the receiver.

In some embodiments, a programmable logic apparatus (e.g., a field programmable gate array) may be used to carry out some or all of the functions of the methods described herein. In some embodiments, a field-programmable gate array can operate in conjunction with a microprocessor in order to carry out one of the methods described herein. In general, the methods are preferably executed by any hardware apparatus.

If some aspects have been described with reference to an apparatus or system, these aspects should also be understood as a description of the corresponding method and vice versa. For example, a block, device or functional aspect of the device or system may correspond to a function, such as a method step, of the corresponding method. Accordingly, aspects described with respect to a method are also to be understood as a description of a corresponding block, a corresponding element, a property or a functional feature of a corresponding device or system.

The following claims are hereby incorporated into the detailed description, with each claim standing on its own as a separate example. It should also be noted that although a dependent claim in the claims refers to a particular combination with one or more other claims, other examples may also comprise a combination of the dependent claim with the subject matter of another dependent or independent claim. Such combinations are hereby expressly suggested, unless it is stated in a specific case that a particular combination is not intended. In addition, features of a claim should also be included for any other independent claim, even if that claim is not directly defined as dependent on that other independent claim.

The aspects and features described with respect to a particular one of the preceding examples may also be combined with one or more of the further examples to replace an identical or similar feature of that further example or to additionally introduce the features into the further example.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

100 optical imaging system
110 specimen
122 transmitted light detector
124 field-of-view scanner
126 specimen stage
130 device
132 interface
134 data processing circuit
136 memory
210 receiving sensor data
220 determining a pixel offset
230 checking for further measurement at the same position
240 checking for trigger event
250 controlling the recording of a drift image
260 checking for further position of the specimen stage for measurement
270 ending the measurement
320 receiving alignment data
330 determining a reliability
340 correcting a setting
410 field-of-view
420 reference image
500 method
510 receiving sensor data
520 receiving trigger data
530 controlling the recording of a drift image
540 determining further sensor data
550 determining a pixel offset
560 determining correction data
570 sending the correction data
600 system
610 microscope
620 computer system

1. A device for an optical imaging system, the device comprising a data processing circuit and a memory, wherein the data processing circuit is configured to:
receive sensor data, wherein the sensor data is indicative of a reference image;
receive trigger data, wherein the trigger data is indicative of a trigger event for determining a drift of the optical imaging system;
control recording a drift image triggered by the trigger event;
receive further sensor data, wherein the further sensor data is indicative of the drift image;
determine a pixel offset between the reference image and the drift image;
determine correction data for correcting the pixel offset based on the pixel offset; and
send the correction data to correct the pixel offset.

2. The device according to claim 1, wherein
the determining the pixel offset comprises at least one of determining an axial pixel offset and determining a lateral pixel offset, and
the correction data is for correcting at least one of the axial pixel offset and the lateral pixel offset.

3. The device according to claim 1, wherein
the correction data is indicative of a setting of a field-of-view scanner or a setting of a specimen stage of the optical imaging system.

4. The device according to claim 1, wherein
the reference image comprises a first focus map, and the drift image comprises a second focus map, and wherein the data processing circuit is configured to:
determine an axial pixel offset by determining an offset of a position of a characteristic structure in the first focus map relative to a position of the characteristic structure in the second focus map.

5. The device according to claim 1, wherein
the trigger event is indicative of exceeding a predefined measurement time, a predefined number of measurement sequences, or a predefined temperature change.

6. The device according to claim 1, wherein
the controlling the recording the drift image comprises controlling a transmitted light detector of the optical imaging system, and wherein
the further sensor data is indicative of the drift image of the transmitted light detector.

7. The device according to claim 1, wherein
the reference image or the drift image is from a first channel of the optical imaging system; and
the correction data for correcting the pixel offset for recording a useful image is from a second channel.

8. The device according to claim 7, wherein
the useful image is a confocal image of a specimen.

9. The device according to claim 1, wherein
determining the pixel offset comprises determining by using a phase cross correlation.

10. The device according to claim 1, wherein the data processing circuit is further configured to:
receive wavelength data, wherein the wavelength data is indicative of a change in a wavelength used for a measurement; and
control recording the reference image triggered by the change in the wavelength.

11. The device according to claim 1, wherein the data processing circuit is further configured to:
receive position data, wherein the position data is indicative of a change in a position of a specimen stage of the optical imaging system; and
control recording the reference image triggered by the change in the position of the specimen stage.

12. The device according to claim 1, wherein the data processing circuit is further configured to:
determine a reliability of the correction data; and
control recording the drift image based on the reliability.

13. The device according to claim 12, wherein
the controlling the recording the drift image comprises setting a size of a measurement region, wherein a smaller measurement region is set for greater reliability.

14. The device according to claim 13,
wherein the measurement region for the recording the drift image is set in at least one of a lateral direction and an axial direction.

15. The device according to claim 1, wherein the data processing circuit is further configured to:
determine a reliability of the correction data; and
determine the correction data for correcting the pixel offset based on the reliability.

16. The device according to claim 1, wherein the data processing circuit is further configured to:
control a light source of the optical imaging system in a pulsed mode; and
determine a characteristic structure in the reference image and in the drift image to determine an axial pixel offset triggered by the pulsed mode of the light source.

17. The device according to claim 1, wherein the data processing circuit is further configured to:
control recording a first drift image to correct an axial pixel offset triggered by the trigger event; and
after the controlling the recording the first drift image, control recording a second drift image to correct a lateral pixel offset.

18. The device according to claim 1, wherein the data processing circuit is further configured to:
determine alignment data for recording an alignment image;
send the alignment data to record the alignment image;
receive alignment sensor data, wherein the alignment sensor data is indicative of the alignment image;
determine a parameter of the optical imaging system for correcting a lateral pixel offset or an axial pixel offset based on the alignment sensor data and the sensor data; and
determine the correction data based on the parameter.

19. The device according to claim 18, wherein:
the determining the alignment data comprises determining a setting of a field-of-view scanner of the optical imaging system; and
the parameter is indicative of a correlation between the lateral pixel offset or the axial pixel offset and the setting of the field-of-view scanner.

20. An optical imaging system, comprising a device according to claim 1.

21. A method for operating an optical imaging system, the method comprising:
receiving sensor data indicative of a reference image;
receiving trigger data indicative of a trigger event for determining a drift of the optical imaging system;
controlling recording a drift image triggered by the trigger event;
receiving further sensor data indicative of the drift image;
determining a pixel offset between the reference image and the drift image;
determining, based on the pixel offset, correction data for correcting the pixel offset; and
sending the correction data to correct the pixel offset.

22. A non-transitory computer-readable medium having a computer program stored thereon, the computer program, when executed by a processor, causing performance of the method according to claim 21.
